(19) United States
(12) Patent Application Publication
(10) Pub. No.: US 2002/0118620 A1
(43) Pub. Date: Aug. 29, 2002

(54) Optical recording medium with wobble header area, and data recording method and apparatus therefor

(76) Inventors: Kyung-geun Lee, Seongnam-si (KR); In-sik Park, Suwon-si (KR); Yoon-gi Kim, Seongnam-si (KR); Tatsuhiro Otsuka, Suwon-si (KR); Jin-hoon Jeon, Suwon-si (KR); Jung-wan Ko, Yongin-si (KR); Du-seop Yoon, Suwon-si (KR)

Correspondence Address: STAAS & HALSEY LLP, 700 11TH STREET, NW, SUITE 500, WASHINGTON, DC, 20001, US

(21) Appl. No.: 09/894,837

(22) Filed: Jun. 29, 2001

(30) Foreign Application Priority Data
Dec. 26, 2000 (KR) 2000-82053

(51) Int. Cl. G11B 7/00

(52) U.S. Cl. 369/53.21; 369/275.4; 369/275.3; 369/116

(57) ABSTRACT

An optical recording medium that includes a wobbled track including a wobble signal and a wobbled header track including a wobble header signal containing header information. Accordingly, the physical geometry of a header area is uniform so that a decrease in the quantity of light reflected from the optical recording medium can be prevented when data is recorded to the recording medium.

### CROSS-REFERENCE TO RELATED APPLICATIONS

This application claims the benefit of Korean Application No. 2000-82053, filed Dec. 26, 2000, in the Korean Industrial Property Office, the disclosure of which is incorporated herein by reference.

### BACKGROUND OF THE INVENTION

1. Field of the Invention

The present invention relates to an optical recording medium, and more particularly, to an optical recording medium with a wobbled track to which a wobble signal is recorded and to which user data can be recorded, and a data recording method and apparatus therefor.

2. Description of the Related Art

An optical recording medium includes a header area to which header information is recorded and a user data area to which user data is recorded. In the case of a 2.65 GB or 4.7 GB DVD-RAM, each sector contains 128 bytes of header information. The header information is recorded in the form of pre-pits during manufacturing of a disc substrate. According to DVD-RAM specifications, the header area includes a variable frequency oscillator (VFO) region for phase locked loop (PLL), a physical identification data (PID) region assigned a sector number, and an ID error detection (IED) region for storing ID error detection information. The header area is disposed at a predetermined portion of a sector. A pickup device provided in a recording/reproducing apparatus can easily recognize a sector number, sector type and a land or groove track based on information recorded on the header area.

As the use of multi media is rapidly spreading, a variety of methods for recording more information on an optical recording medium such as a digital versatile disc (DVD) have been proposed. For example, there are methods of broadening a user data area to which user data can be recorded, reducing the wavelength of a recording or reproducing laser, and decreasing a track pitch.

FIG. 1 is a schematic diagram of a conventional optical disc. Referring to FIG. 1, land and groove tracks corresponding to a user data area to which user data is recorded are formed on the optical disc. Header areas 3 to which header information is recorded in the form of pre-pits are also disposed on the optical disc.

FIGS. 2A through 2D shows examples of a header area 3 of a conventional optical disc. Referring to FIG. 2A, the pre-pits used to record header information are disposed in the middle of each of the land and groove tracks. In other words, the pre-pits are assigned to each track. In this structure, a track and the associated pre-pits are disposed on the same circumference so that a wobble signal and header information can be recorded at one time. However, if the density of tracks is increased to improve the recording density, cross-talk may occur during reproduction of header information.

Referring to FIG. 2B, the pre-pits are disposed at the border between a land track and a groove track. In this structure, even if the density of tracks is increased, cross-talk does not occur as easily in comparison with the structure of FIG. 2A. In addition, an area on which the pre-pits can be recorded is widened so that the width of a pit can be increased. In other words, the structure of FIG. 2B is preferable to that of FIG. 2A in terms of signal reproduction. However, since the pre-pits are disposed on the border between a land track and a groove track, this structure is vulnerable to the tracking offset of a pickup device during recording or reproducing.

Referring to FIG. 2C, a group of the pre-pits is disposed in the middle of each land or groove track such that the group of the pre-pits in one track is not adjacent to another group of the pre-pits in an adjacent track. Accordingly, even if the density of the tracks is increased, a probability that cross-talk occurs between adjacent tracks is very low. However, since the pre-pits are disposed in the middle of each track, this structure is insensitive to a tracking error so that it is difficult to perform smart servo control.

A structure shown in FIG. 2D is used in present DVD-RAMs. A group of the pre-pits is disposed on the border between a land track and a groove track such that the group of the pre-pits in one track is not adjacent to another group of pre-pits in an adjacent track. Accordingly, cross-talk can be reduced, and smart servo control can be achieved. However, it is difficult to position the pre-pits, which are not adjacent between adjacent tracks, during manufacture of a disc substrate. Accordingly, the signal characteristics of elements constituting a header area may not be in accord with each other.

In a conventional DVD-RAM, the proportion of a header area 3 to a disc area reaches 5% per sector. To increase a user data area by minimizing such an overhead, a dual layer structure having two data recordable sides is used. However, in such a dual layer structure, the recording power is influenced by the physical geometry of a lower layer when data is recorded to an upper layer.

To derive an improvement, the influence of the physical geometry of a header area 3, which is recorded in the form of pre-pits according to the prior art, exerts on recording power in a dual layer structure was simulated and measured. To simulate the quantity of reflected light, the quantity of light reflected from each of a mirror substrate, a groove area, a pit area, and a groove area with marks was calculated as shown in FIGS. 3A through 3D. A curvature of 30 μm was applied to a lens 1 considering the effect of a space layer between a lower layer and an upper layer in the dual layer structure. In addition, the number of tracks of the lower layer captured by laser beams passing through the lens was considered during the calculation.

To measure the quantity of the reflected light, conditions as shown in FIGS. 4A through 4C were set. Here, “L0” denotes a lower layer, and “L1” denotes an upper layer. A reflective film 2 is formed below the upper layer L1. Laser beams are focused on a mirror area in FIG. 4A, on a pit area in FIG. 4B, and on a groove area (with no marks) in FIG. 4C.

FIG. 5 is a graph showing the results obtained from FIGS. 3A through 4C. In calculations from the simulations, a track pitch was doubled to cover the structure as shown in FIG. 2A. For the groove area with marks, only the difference in reflectivity between a marked portion and a land or groove portion was considered. A difference in the transmittance of the marked portion due to a difference in absorptance between an amorphous state and a crystalline state was not considered.

The followings are the tables of input parameters and their values for experiments.

TABLE 1

| Parameters | Values |
|---|---|
| Wavelength (nm) | 400 |
| Numerical aperture (NA) of an | 0.65 |
| objective lens | |
| Minimum mark length (μm) | 0.275 |
| Modulation | EFM+ |
| Track pitch (TP) (μm) | 0.30, 0.34, 0.38 |
| Reflectivity (%) | Rc = 28, Ra = 10 |

TABLE 2

| Items | Factors | Examples |
|---|---|---|
| Dual | Transmittance of L0 | 60% |
| layer | Geometry of L0 | Groove, pit, . . . |
| High | Number of tracks ranged over by a | NA 0.65: 85 tracks |
| NA | beam | → |
| | | NA 0.85: 160 tracks |
| | Angle of an incident beam → Reduction | NA 0.65: 40.5° |
| | of transmittance | → |
| | | NA 0.85: 58.2° |

According to the simulations, the transmittance decreased the least at the mirror substrate, and decreased the most in order of the pit area and the groove area. Depending on the track pitch, the transmittance decreased by 4-7.5% at the pit area, while the transmittance decreased by 7.5-28.5% at the groove area.

The quantity of light reflected from the pit area was measured at a track pitch of 0.37 μm and decreased by 0-4%. In the case of the groove area, a decrease in a measured value was less than a decrease in the calculated value. It is inferred that this phenomenon occurs because it was assumed that a wall angle was 90° in the simulations, but a practical wall angle was less than 60°, so that the measured quantity of light was 3% larger than the calculated one.

As a track pitch decreases, the quantity of transmitted light decreases at the pit and groove areas. A measured value obtained at a track pitch of 0.34 μm (practically, 0.34 μm×2) was 0-4% smaller than a reference value obtained at a track pitch of 0.38 μm (practically, 0.38 μm×2). However, when a header area 3 has a structure as shown in FIG. 2D, it is inferred that the quantity of transmitted light decreases less. A decrease in the quantity of transmitted light was 9.5% at a track pitch of 0.34 μm and 22% at a track pitch of 0.30 μm at the groove area. When a track pitch was 0.34 μm, a measured value is 7.5% smaller than a calculated value.

As a result, it can be inferred that the upper layer L1 needs to have at least a 20% larger recording power than the lower layer L0 at the groove area when a track pitch is 0.30 μm and the NA of an objective lens is 0.85. In other words, the header area 3 having the pre-pits is not suitable for high density recording and influences recording power when data is recorded to the upper layer of a dual layer structure.

### SUMMARY OF THE INVENTION

To solve the above and other problems, it is an object of the present invention to provide an optical recording medium with a physical geometry that does not influence a recording power, and a data recording method and apparatus therefor.

It is another object of the present invention to provide an optical recording medium to prevent degradation of a header area by repetitive recording, and a data recording method and apparatus therefor.

Additional objects and advantages of the invention will be set forth in part in the description which follows and, in part, will be obvious from the description, or may be learned by practice of the invention.

To achieve the above and other objects of the invention, an optical recording medium according to an embodiment of the present invention includes a wobbled track to which a wobble signal is recorded, and a wobbled header track to which a wobble header signal containing header information is recorded.

According to an aspect of the present invention, the wobbled header track and the wobbled track are alternately disposed with each other, where the wobbled track has a user data area to which user data is recorded and a land track or a groove track.

According to another aspect of the present invention, the wobble signal has a single frequency, and the wobble header signal has a frequency which is higher than the frequency of the wobble signal and is obtained by modulating binary data containing the header information.

According to a further aspect of the present invention, the modulation is done by quadrature phase shift keying (QPSK), and the header information includes addressing information.

According to another embodiment of the present invention, a method of recording data on a recording medium which includes a wobbled track, to which a wobble signal is recorded, and a wobbled header track, to which a wobble header signal containing header information is recorded, includes recording data to the wobbled track with a predetermined recording power, and passing the wobbled header track with passing power which is lower than the recording power by a predetermined value.

According to an aspect of the present invention, the method further includes detecting the wobbled header track before the passing the wobbled header track, and the passing power is the same as a reproducing power which is used to reproduce the data from the recording medium.

According to another aspect of the present invention, the wobbled header track and the wobbled track are alternately disposed with each other.

According to a further aspect of the present invention, the wobble signal has a single frequency, and the wobble header signal has a frequency which is higher than the frequency of the wobble signal and is obtained by modulating binary data containing the header information.

According to a still further aspect of the present invention, the modulation is done by quadrature phase shift keying (QPSK), and the header information includes addressing information.

According to a further embodiment of the present invention, an apparatus is to record data on a recording medium which includes a wobbled track, to which a wobble signal is recorded, and a wobbled header track, to which a wobble header signal containing header information is recorded, the apparatus includes a recording unit to record data to the wobbled track with a predetermined recording power and to pass the wobbled header track with a passing power which is lower than the recording power by a predetermined value.

According to an aspect of the present invention, the passing power is the same as reproducing power which is used for reproducing data from the recording medium.

According to another aspect of the present invention, the wobbled header track and the wobbled track are alternately disposed with each other.

According to a further aspect of the present invention, the wobble signal has a single frequency, and the wobble header signal has a frequency which is higher than the frequency of the wobble signal and is obtained by modulating binary data containing the header information.

According to a still further aspect of the present invention, the modulation is done by quadrature phase shift keying (QPSK), and the header information includes addressing information.

### BRIEF DESCRIPTION OF THE DRAWINGS

The above and other objectives and advantages of the present invention will become more apparent and more readily appreciated by describing in detail preferred embodiments thereof with reference to the attached drawings in which:

FIG. 1 is a schematic diagram of a conventional optical disc;

FIGS. 2A through 2D show examples of a header area of a conventional optical disc;

FIGS. 3A through 3D are diagrams to simulate a decrease in the quantity of reflected light from the conventional optical disc;

FIGS. 4A through 4C are diagrams to measure a decrease in the quantity of reflected light from the conventional optical disc;

FIG. 5 is a graph showing the results obtained from the simulations shown in FIGS. 3A through 4C;

FIG. 6 is a schematic diagram of an optical disc according to an embodiment of the present invention;

FIG. 7 is a detailed partial diagram of FIG. 6;

FIG. 8 is a block diagram of a recording apparatus to record user data on the optical disc shown in FIGS. 6 and 7 according to an embodiment of the present invention;

FIG. 9 is a flowchart of a data recording method according to an embodiment of the present invention; and

FIGS. 10A and 10B are diagrams to explain the relationship between the recording power and the passing power in the data recording method according to the embodiment of the present invention.

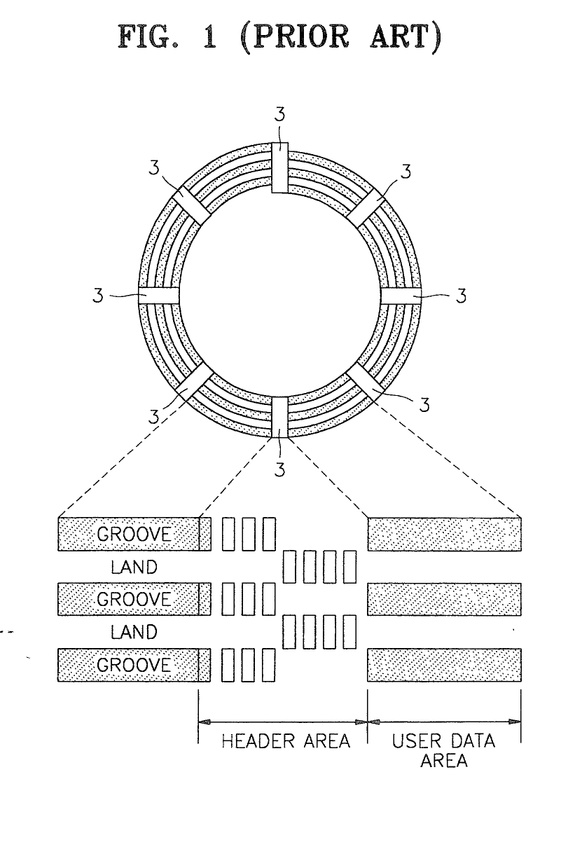

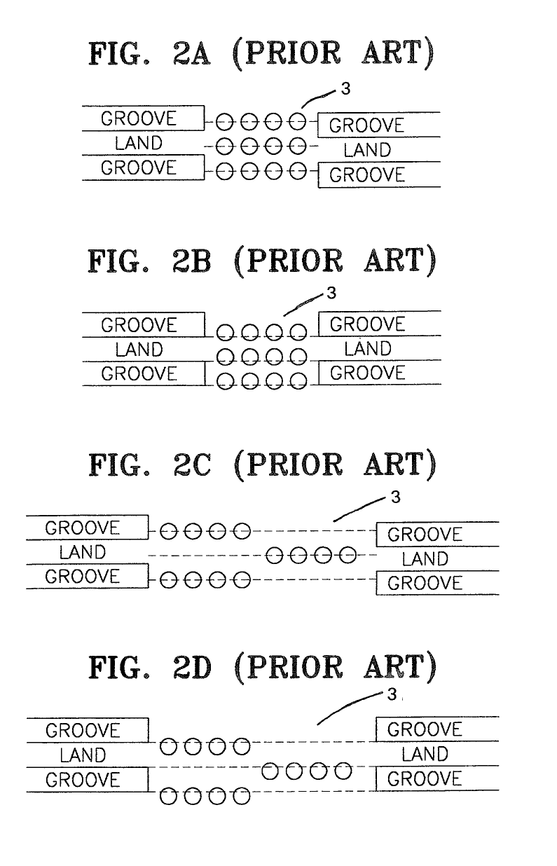

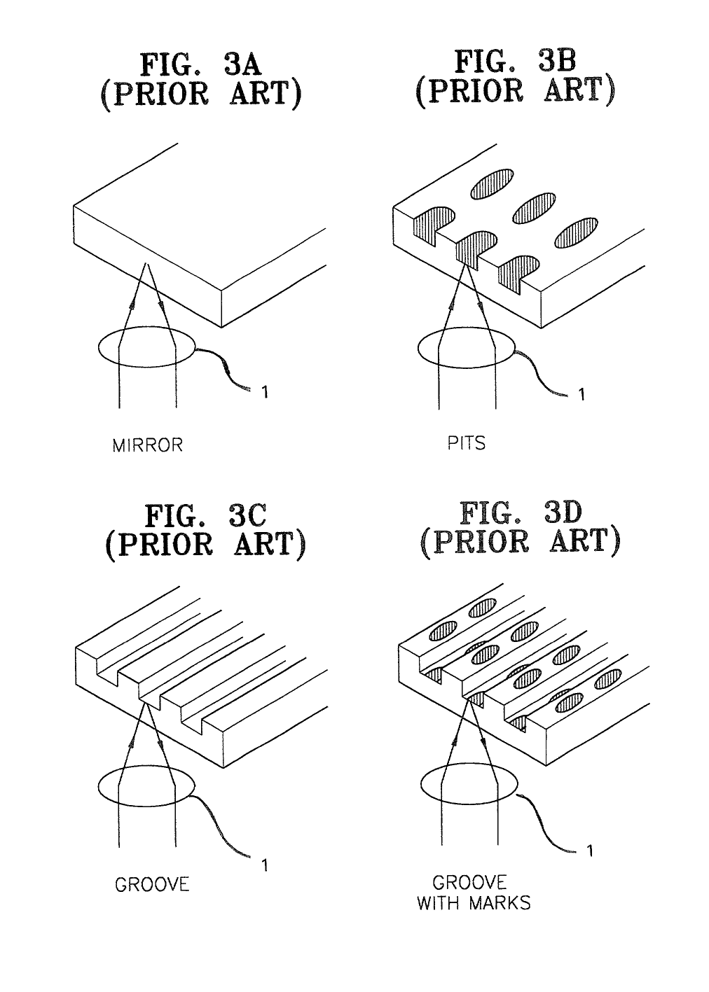

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

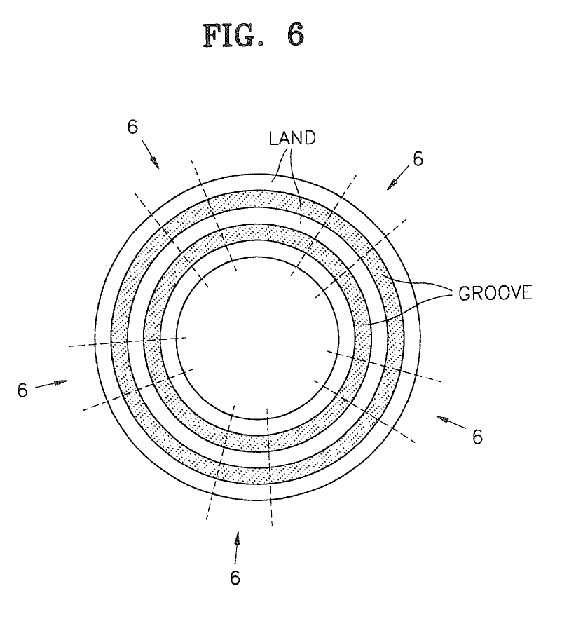

Referring to FIG. 6, a groove is a tracking mechanism to precisely track a recording laser beam and is formed along a track on an optical disc according to an embodiment of the present invention. A land corresponds to the surface of a disc substrate that exists between the grooves.

A wobble signal of a specific frequency is recorded on a groove track and/or a land track. The wobble signal is a mechanism to record an auxiliary clock signal to obtain synchronizing information during recording or reproduction. In other words, the wobble signal is used as an auxiliary signal to supplement a system clock. Therefore, the wobble signal has a frequency band that does not influence a tracking servo mechanism used in a recording/reproducing apparatus. According to DVD-RAM specifications, a servo band to track in a radial direction is about 10 KHz, and the frequency of the wobble signal is about 157 KHz at a standard linear velocity. The user data is recorded to a groove track and/or a land track. Each track is divided into a plurality of sectors for management. A header area 6 corresponding to each sector is disposed on each track. The header information is recorded to each header area 6. The header information includes sector information of an optical disc and address information, which is information for identifying a sector.

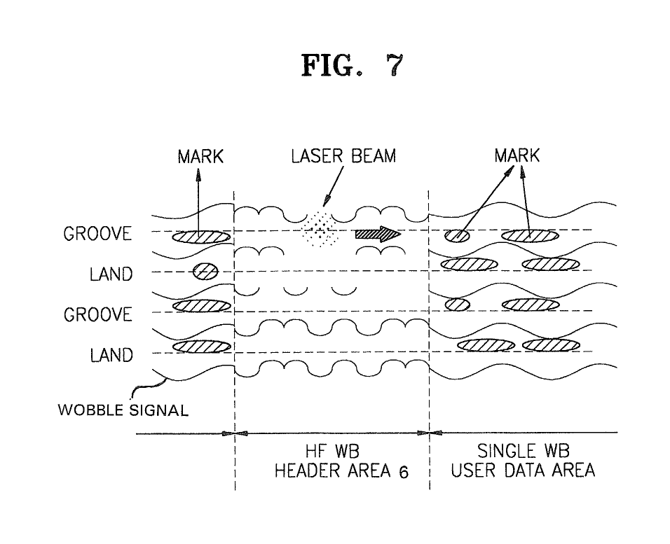

FIG. 7 is a partial detailed diagram of FIG. 6. Referring to FIG. 7, a single wobble signal having a single frequency is recorded to each of the groove and land tracks. A phase transition layer allowing overwrite is formed on the groove and land tracks so that the marks are formed during recording of user data. These marks can be recorded by a data recording apparatus which will be described later. In the header area 6, a track continues so that it corresponds to the groove or land track of an adjacent user data area. A wobble header signal contains header information and is recorded to the track in the header area 6. For a clear description, a groove or land track in a user data area is referred to as a wobbled track, and a track in a header area 6 is referred to as a wobbled header track.

A wobble header signal recorded to a wobbled header track 6 contains various kinds of header information. Accordingly, the wobble header signal has a frequency higher than a wobble signal recorded to a wobbled track. Here, the wobble header signal is a bi-phase modulated signal. Specifically, the wobble header signal is a quadrature phase shift keying (QPSK) signal. However, it is understood that other types of modulation and phase shift keying are available.

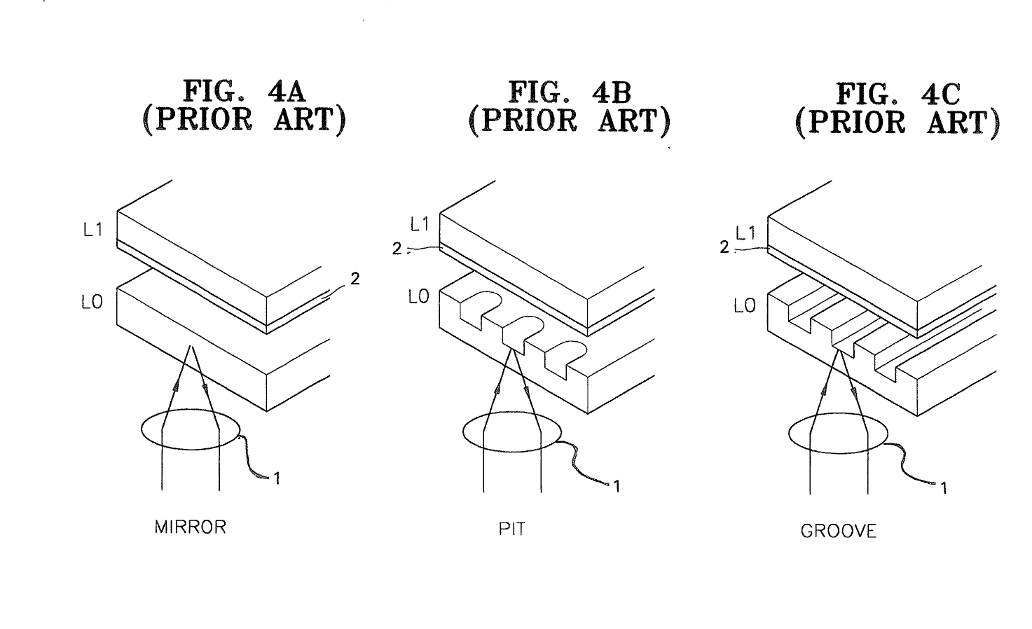

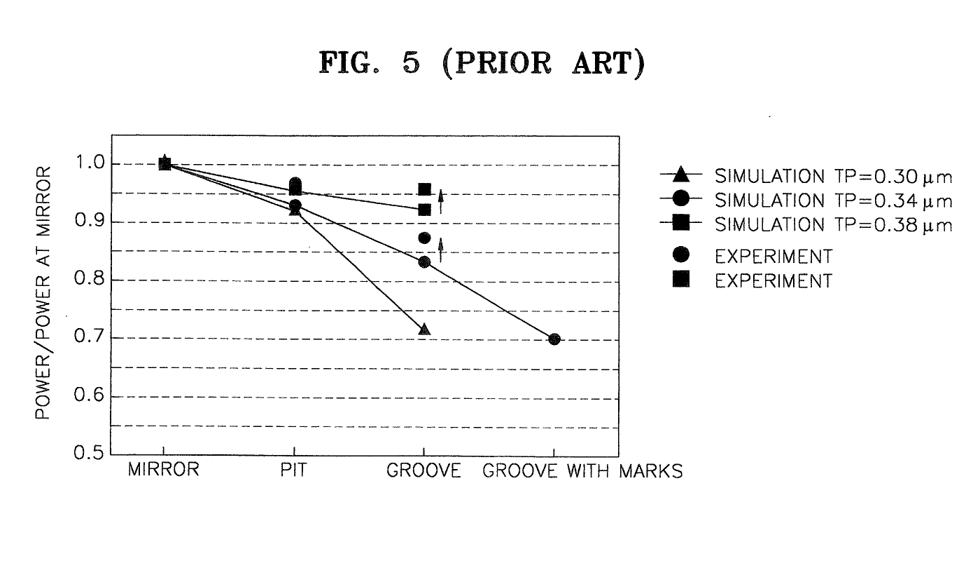

A header area 6 on an optical recording medium according to the present invention is configured as a wobbled header track to which a wobble header signal is recorded so that its physical geometry is much more uniform than that of a conventional header area 3 formed of the pre-pits. Accordingly, a decrease in the quantity of light, which has been described with reference to FIGS. 3A through 5, rarely occurs when data is recorded to an upper layer in a dual layer structure.

FIG. 8 is a block diagram of a recording apparatus 8 to record the user data to the optical disc shown in FIGS. 6 and 7 according to an embodiment of the present invention. Referring to FIG. 8, the recording apparatus 8 includes a controller 80, a laser beam generator 81, an electro-optical (EO) modulator 82, and an optical recording/detection unit 83. The controller 80 appropriately controls the laser beam generator 81, the EO modulator 82 and the optical recording/detection unit 83 so that user data can be recorded to a user data area on an optical disc 10. The controller 80 can be a computer having a computer readable medium encoded with instructions to control the operations of the recording apparatus 8. The laser beam generator 81 oscillates a laser beam and then reduces the noise of the oscillated laser beam to stabilize a recording power. For a recording laser beam, a blue laser beam or an ultraviolet laser beam can be used. Usually, an Ar ion laser or a Kr laser is used to generate the ultraviolet laser beam. The EO modulator 82 modulates a passing power when necessary and enlarges the diameter of a laser beam so that the laser beam is fully incident on an objective lens 1 (not shown) provided in the optical recording/detection unit 83. The optical recording/detection unit 83 records data to the optical disc 10 using the smallest width of the laser beam.

In addition, the optical recording/detection unit 83 detects a user data area or a header area 6. A header area 6 can be detected by the optical recording/detection unit 83 according to a variety of methods. For instance, a phase modulated wobble signal is recorded to a predetermined portion on a wobbled track adjacent to a header area 6, and the phase modulated wobble signal is detected. According to this method, the phase modulated wobble signal functions as a flag indicating a header area 6. Also, the phase modulated wobble signal recorded to the header area 6 may be a wobble signal modulated by binary-phase shift keying (BPSK). In another example, a mirror section to which a wobble signal is not recorded is formed at a predetermined portion on a wobbled track adjacent to a header area 6. It will be apparent that, among the conventional methods used for detecting a header area 6, there are multiple methods which can be applied to an optical recording medium according to the present invention.

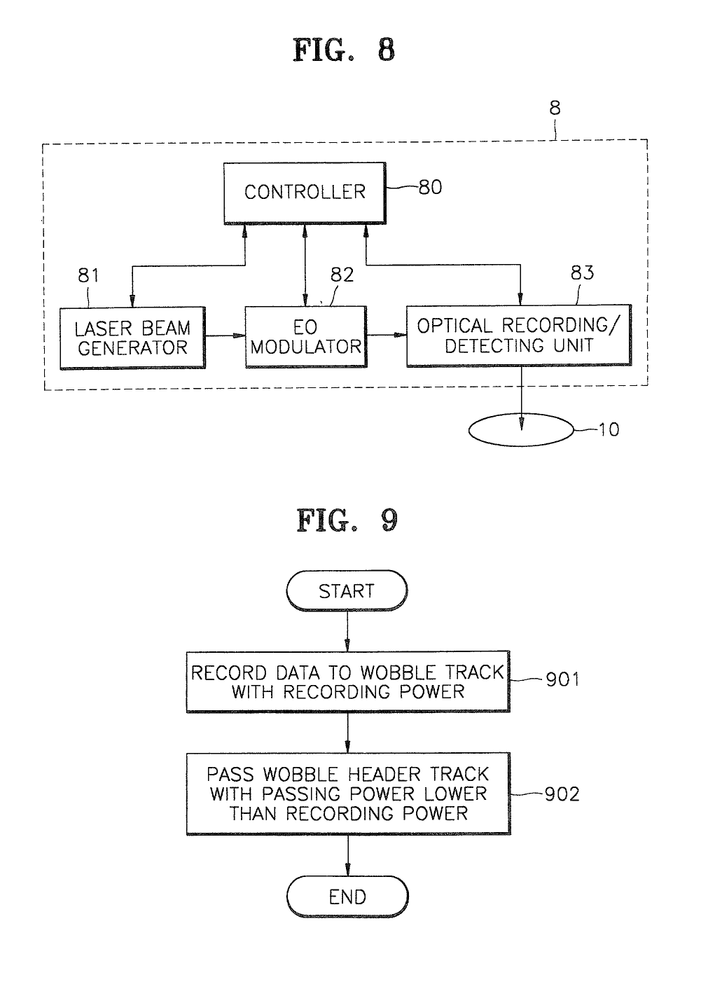

FIG. 9 is a flowchart of a data recording method according to an embodiment of the present invention. An optical recording medium to which data is recorded is the optical disc described with reference to FIGS. 6 and 7. The data is recorded to a user data area on the optical disc. Where the controller 80 is a computer, the method of FIG. 9 is a computer program encoded on a computer readable medium internal or external to the controller 80.

Referring to FIG. 9, in operation 901, the controller 80 controls the optical recording/detection unit 82 to record data to a wobbled track in a user data area with a predetermined recording power so that the user data is recorded with the predetermined recording power. When a header area 6 is detected by the optical recording/detection unit 83, in operation 902, the controller 80 controls the predetermined recording power to be lowered to a reproducing power so that the optical recording/detection unit 83 passes the header area 6 with the reproducing power without recording data. In other words, the passing power is the reproducing power. However, it is understood that the passing power may be variously selected from the values lower than the value of the recording power so as to not record data in the header area 6.

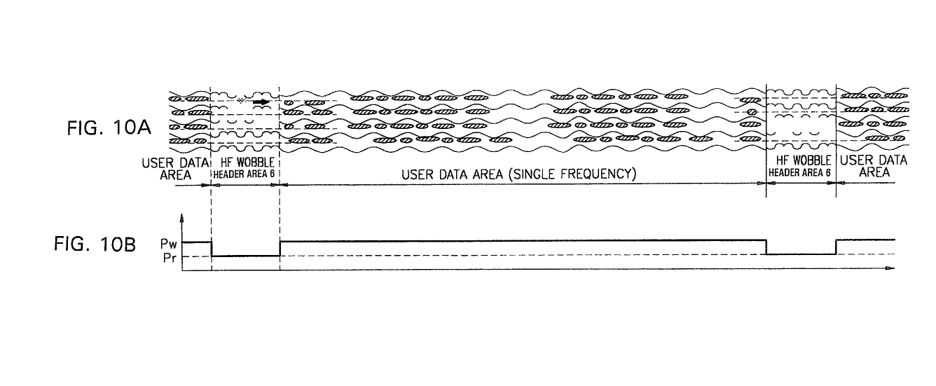

FIGS. 10A and 10B are diagrams explaining the relationship between the recording power and the passing power in the data recording method according to the embodiment of the present invention. Referring to FIG. 10A, a single wobble signal of low frequency is recorded to a wobbled track formed in a user data area, and a wobble header signal of high frequency (HF) is recorded to a wobbled header track formed in a header area 6. As shown in FIG. 10B, the recording power Pw is output from the optical recording/detection unit 83 when the recording apparatus 8 records data (i.e., forms marks) on the user data area. The passing power Pr is output from the optical recording/detection unit 83 when the recording apparatus 8 passes the header area 6. The passing power Pr is the same as the reproducing power Pr, which is lower than the recording power Pw. As described above, since the recording power Pw is lowered to the reproducing power Pr when a recording apparatus passes the header area 6 to which a wobble header signal containing header information is recorded, a phase does not change on a wobbled header track in the header area 6 even if recording is repeated so as to not degrade the wobble header signal. It is understood that the recording power Pw may be changed to a power that is lower than the recording power Pw instead of the reproducing power Pr. However, using the reproducing power Pr facilitates control because the level of power can be controlled with just two modes of the recording power Pw and the reproducing power Pr in a recording/reproducing apparatus.

As described above, according to the present invention, the physical geometry of a header area is uniform such that the decreased quantity of the light during recording is reduced, and a data recording method and apparatus therefor. In addition, since the recording power is lowered to the reproducing power in the header area while the data is being recorded to an optical recording medium according to the present invention, a change in the phase of the header area is suppressed so that the degradation of the header area can be substantially prevented.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical recording medium comprising:
a wobbled track comprising a wobble signal; and
a wobbled header track comprising a wobble header signal comprising header information.

2. The optical recording medium of claim 1, said wobbled header track and said wobbled track are disposed to alternate with each other.

3. The optical recording medium of claim 2, wherein said wobbled track further comprises a user data area comprising user data and a land track or a groove track.

4. The optical recording medium of claim 1, wherein the wobble signal comprises a single frequency.

5. The optical recording medium of claim 4, wherein the wobble header signal comprises another frequency which is higher than the single frequency of the wobble signal.

6. The optical recording medium of claim 5, wherein the wobble header signal is modulated binary data containing the header information.

7. The optical recording medium of claim 6, wherein the modulation is done by quadrature phase shift keying (QPSK).

8. The optical recording medium of claim 1, wherein the header information further comprises addressing information.

9. A method of recording data to a recording medium which comprises a wobbled track comprising a wobble signal and a wobbled header track comprising a wobble header signal containing header information, the method comprising:
recording data to the wobbled track with a predetermined recording power; and
passing the wobbled header track with a passing power which is lower than the recording power by a predetermined value.

10. The method of claim 9, further comprising detecting the wobbled header track before said passing the wobbled header track.

11. The method of claim 10, wherein the passing power is the same as a reproducing power which is used to reproduce the data from the recording medium.

12. The method of claim 9, wherein the wobbled header track and the wobbled track are disposed to alternate with each other.

13. The method of claim 9, wherein the wobble signal has a single frequency.

14. The method of claim 13, wherein the wobble header signal has another frequency which is higher than the single frequency of the wobble signal.

15. The method of claim 14, wherein the wobble header signal is modulated binary data containing the header information.

16. The method of claim 15, wherein the modulation is done by quadrature phase shift keying (QPSK).

17. The method of claim 9, wherein the header information further comprises addressing information.

18. An apparatus to record/reproduce data on/from a recording medium which comprises a wobbled track comprising a wobble signal and a wobbled header track comprising a wobble header signal comprising header information, the apparatus comprising:
a recording unit to record the data to the wobbled track with a predetermined recording power, and to pass the wobbled header track with a passing power which is lower than the recording power by a predetermined value.

19. The apparatus of claim 18, wherein the passing power is the same as a reproducing power which is used to reproduce the data from the recording medium.

20. The apparatus of claim 18, wherein the wobbled header track and the wobbled track are disposed to alternate with each other.

21. The apparatus of claim 18, wherein the wobble signal has a single frequency.

22. The apparatus of claim 21, wherein the wobble header signal has another frequency which is higher than the single frequency of the wobble signal.

23. The apparatus of claim 22, wherein the wobble header signal is modulated binary data containing the header information.

24. The apparatus of claim 23, wherein the modulation is done by quadrature phase shift keying (QPSK).

25. The apparatus of claim 18, wherein the header information comprises addressing information.

26. The optical recording medium of claim 1, wherein said wobbled header track and said wobbled track are disposed adjacent to each other along a common land track or groove track.

27. The optical recording medium of claim 26, wherein said wobbled track further comprises user information recorded adjacent to the wobble signal.

28. The optical recording medium of claim 27, wherein the wobble signal comprises an auxiliary clock signal.

29. The optical recording medium of claim 1, wherein said wobbled track further comprises a phase modulated wobble signal adjacent to a header area containing said wobbled header track.

30. The optical recording medium of claim 29, wherein the phase modulated wobble signal is modulated by binary-phase shift keying.

31. The optical recording medium of claim 28, wherein said wobbled track further comprises a phase modulated wobble signal adjacent to a header area containing said wobbled header track.

32. The optical recording medium of claim 31, wherein the phase modulated wobble signal is modulated by binary-phase shift keying.

33. The optical recording medium of claim 1, wherein said wobbled track further comprises a mirror region disposed adjacent to said wobbled header track.

34. The optical recording medium of claim 28, wherein said wobbled track further comprises a mirror region disposed adjacent to a header area containing said wobbled header track.

35. The method of claim 10, wherein said detecting the wobbled header track comprises detecting whether the wobble signal is a phase modulated wobble signal.

36. The method of claim 10, wherein said detecting the wobbled header track comprises detecting a mirror region.

37. The apparatus of claim 18, wherein said recording unit further detects the whether the wobble signal is a phase modulated wobble signal to detect the wobbled header track.

38. The apparatus of claim 18, wherein said recording unit further detects a mirror region to detected the wobbled header track.

39. A computer readable medium encoded with processing instructions for implementing a method of recording data to a recording medium which comprises a wobbled track comprising a wobble signal and a wobbled header track comprising a wobble header signal containing header information performed by a computer, the method comprising:
recording data to the wobbled track with a predetermined recording power; and
passing the wobbled header track with a passing power which is lower than the recording power by a predetermined value.

40. The computer readable medium of claim 39, further comprising detecting the wobbled header track before said passing the wobbled header track.

41. The computer readable medium of claim 40, wherein the passing power is the same as a reproducing power which is used to reproduce the data from the recording medium.

42. The computer readable medium of claim 39, wherein the wobbled header track and the wobbled track are disposed to alternate with each other.

43. The computer readable medium of claim 39, wherein the wobble signal has a single frequency.

44. The computer readable medium of claim 43, wherein the wobble header signal has another frequency which is higher than the single frequency of the wobble signal.

45. The computer readable medium of claim 44, wherein the wobble header signal is modulated binary data containing the header information.

46. The computer readable medium of claim 45, wherein the modulation is done by quadrature phase shift keying (QPSK).

47. The computer readable medium of claim 39, wherein the header information further comprises addressing information.

48. The method of claim 40, wherein said detecting the wobbled header track comprises detecting whether the wobble signal is a phase modulated wobble signal.

49. The method of claim 40, wherein said detecting the wobbled header track comprises detecting a mirror region.

50. An optical recording medium comprising:
a first modulated signal disposed in a track; and
a second modulated signal comprising header information referring to the track.

51. The optical recording medium of claim 50, wherein said first modulated signal comprises an auxiliary clock signal and is disposed in an area to which information is to be recorded.

52. The optical recording medium of claim 51, wherein said second modulated signal comprises sector information identifying the sector including the track and is disposed in a header area.

53. The optical recording medium of claim 50, wherein a modulation frequency of said first modulated signal is different from a modulation frequency of said second modulated signal.

54. The optical recording medium of claim 50, further comprising a third modulated signal comprising said first modulated signal which has been additionally modulated, said third modulated signal is adjacent to said second modulated signal and has a modulation frequency different from modulated frequencies of said first and second modulated signals.

55. The optical recording medium of claim 50, further comprising a mirror region adjacent to said second modulated signal.

56. A method of recording information to a recording medium, comprising:
recording the information to a track of the optical recording medium; and
detecting a flag in the track during said recording so as to not record information onto an area containing header information.

57. The method of claim 56, wherein the header information is modulated as to form a wobbled header track.

58. The method of claim 57, wherein the track comprises a wobble signal as to form a wobbled track.
